(19) United States
(12) Patent Application Publication
(10) Pub. No.: US 2018/0318899 A1
(43) Pub. Date: Nov. 8, 2018

(54) SYSTEM AND METHOD FOR MODEL-BASED PIPE BENDING INSTRUCTIONS

(71) Applicant: General Electric Company, Schenectady, NY (US)

(72) Inventors: Miller Glenn Byrd, Greer, SC (US); Chad Kay, Williamston, SC (US); Kevin Sopko, Simpsonville, SC (US); James L. Davis, Taylors, SC (US)

(21) Appl. No.: 15/584,966

(22) Filed: May 2, 2017

(51) Int. Cl. B21D 7/12

(52) U.S. Cl. CPC B21D 7/12; B21D 7/14; G06F 2217/34

(57) ABSTRACT

Systems and methods for enhanced pipe-bending are provided. In one embodiment, a method includes: receiving, via a processor, a piping CAD model. One or more bends of the piping CAD model are identified. Relevant bending information for each bend of the one or more bends is calculated. The relevant bending information is aggregated as relevant bending information is calculated for each bend. The relevant information is formatted into a readable format and is provided to a pipe-bending manufacturer.

### BACKGROUND

The subject matter disclosed herein relates to systems and methods for pipe bending instructions of piping parts, such as industrial machine piping parts.

Industrial machines, such as gas turbine systems, may be quite complex, utilizing complex piping networks. The piping networks of these industrial machines and machine parts may be designed for a particular purpose, such as a pipe manifold designed to transport fluids (e.g., air, fuel). Because these piping networks may be quite complex, it may be beneficial to improve the efficiency of manufacturing/fabrication of machine and machine parts.

### BRIEF DESCRIPTION

Certain embodiments commensurate in scope with the originally claimed embodiments are summarized below. These embodiments are not intended to limit the scope of the claimed embodiments, but rather these embodiments are intended only to provide a brief summary of possible forms of the embodiments. Indeed, the embodiments may encompass a variety of forms that may be similar to or different from the embodiments set forth below.

In a first embodiment, a tangible, non-transitory computer-readable medium, includes machine-readable-instructions to: access a computer aided design (CAD) model and identify one or more bends of the CAD model. The machine-readable-instructions are also to: determine bend characteristics of each bend of the one or more bends, generate bending instructions based on the determined bend characteristics, and provide the bending instructions to a pipe-bending manufacturer.

In a second embodiment, a method includes: receiving, via a processor, a piping CAD model. One or more bends of the piping CAD model are identified. Relevant bending information for each bend of the one or more bends is calculated. The relevant bending information is aggregated as relevant bending information is calculated for each bend. The relevant information is formatted into a readable format and is provided to a pipe-bending manufacturer.

In a third embodiment, a computer includes a memory and a processor. The processor is configured to access a CAD model. One or more bends of the CAD model are identified. Bend characteristics of each bend of the one or more bends are determined. Bending instructions are generated based on the determined bend characteristics, and the bending instructions are provided to a pipe-bending manufacturer.

### BRIEF DESCRIPTION OF THE DRAWINGS

These and other features, aspects, and advantages of the present embodiments will become better understood when the following detailed description is read with reference to the accompanying drawings in which like characters represent like parts throughout the drawings, wherein:

FIG. 1 is a block diagram of an embodiment of a computer-aided technology 2

FIG. 2 is a block diagram of a certain components of the CAx system of FIG. 1;

FIG. 3 is a block diagram of an industrial system that may be conceived, designed, engineered, manufactured, and/or service and tracked by the CAx system of FIG. 1;

FIG. 4 is a block diagram of an embodiment of a system that provides pipe bending instructions to a pipe bending operator and/or machine;

FIG. 5 is a block diagram of an embodiment of a process to perform a pipe bend us a CAD model;

FIG. 6 is an process of an embodiment of creating model-based pipe bending instructions; and

FIG. 7 is an illustration of embodiments of pipe bending instructions that may be generated based upon a CAD model.

### DETAILED DESCRIPTION

One or more specific embodiments will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments, the articles “a,” “an,” “the,” and “said” are intended to mean that there are one or more of the elements. The terms “comprising,” “including,” and “having” are intended to be inclusive and mean that there may be additional elements other than the listed elements.

Designing a machine or part may include certain systems and methods described in more detail below that produce a part design. For example, the part design may be created as a model-based definition included in a three-dimensional (3D) computer aided design (CAD) model and or a two-dimensional (2D) CAD model. The techniques described herein may translate the part design into pipe-bending instructions that are readable by an operator (e.g., pipe manufacturer) and/or machine (e.g., pipe-bending machine).

To translate the part design to an operator-readable (e.g., human-readable) format, a translation tool may be utilized. In the embodiment where the part design is a pipe design, the translation tool may calculate how pipe spool (e.g., pipe stock, prefabricated pipe components) may be modified to fit the pipe design. The translation tool may then generate an operator-readable and/or machine-readable output containing instructions of how to create the pipe design. In turn, the pipe operator and/or machine may receive the output from the translation tool, the output indicating how to manufacture the pipe design from the pipe spool. Next, the pipe operator and/or machine may modify (e.g., bend) the pipe spool according to instructions provided in the output.

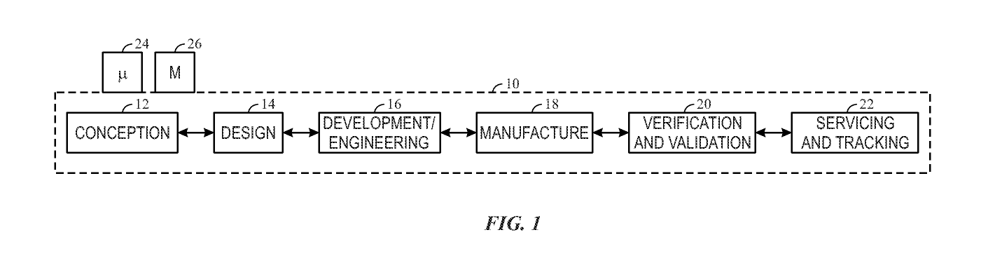

With the foregoing in mind, it may be useful to describe a computer-aided technologies (CAx) system that may incorporate the techniques described herein, for example, to improve product lifecycle management (PLM) processes. Accordingly, FIG. 1 illustrates an embodiment of a CAx system 10 suitable for providing for a variety of processes, including PLM processes 12, 14, 16, 18, 20, 22. In the depicted embodiment, the CAx system 10 may include support for execution of conception processes 12. For example, the conception processes 12 may produce a set of specifications such as requirements specifications documenting a set of requirements to be satisfied by a design, a part, a product, or a combination thereof. The conception processes 12 may also produce a concept or prototype for the part or product (e.g., machine). A series of design processes 14 may then use the specifications and/or prototype to produce, for example, one or more 3D design models of the part or product. The 3D design models may include solid/surface modeling, parametric models, wireframe models, vector models, non-uniform rational basis spline (NURBS) models, geometric models, and the like. For example, a piping system, which may include pipe components, may be produced via design process 14 in 3D and/or 2D modeling software.

Design models may then be further refined and added to via the execution of development/engineering processes 16. The development/engineering processes may, for example, create and apply models such as thermodynamic models, low cycle fatigue (LCF) life prediction models, multibody dynamics and kinematics models, computational fluid dynamics (CFD) models, finite element analysis (FEA) models, and/or three-dimension to two-dimension FEA mapping models that may be used to predict the behavior of the part or product during its operation. For example, turbine piping may be modeled to predict fluid flows, pressures, stresses, and the like, during operations of a gas turbine engine. More specifically, piping modeled in 3D design software may be analyzed in order to generate a file of the piping that is compatible with stress analysis software. The development/engineering processes 16 may additionally result in tolerances, materials specifications (e.g., material type, material hardness), clearance specifications, and the like.

The CAx system 10 may additionally provide for manufacturing processes 18 that may include manufacturing automation support. For example, additive manufacturing models may be derived, such as 3D printing models for material jetting, binder jetting, vat photopolymerization, powder bed fusion, sheet lamination, directed energy deposition, material extrusion, and the like, to create the part or product. Other manufacturing models may be derived, such as computer numeric control (CNC) models with G-code to machine or otherwise remove material to produce the part or product (e.g., via milling, lathing, plasma cutting, wire cutting, and so on). In some embodiments, a CNC machine may be utilized to bend pipe spool according to instructions (e.g., G-code) provided by a translation tool. Bill of materials (BOM) creation, requisition orders, purchasing orders, and the like, may also be provided as part of the manufacture processes 18 (or other PLM processes).

The CAx system 10 may additionally provide for verification and/or validation processes 20 that may include automated inspection of the part or product as well as automated comparison of specifications, requirements, and the like. In one example, a coordinate-measuring machine (CMM) process may be used to automate inspection of the part or product. After the part is inspected, results from the CMM process may be automatically generated via an electronic Characteristic Accountability & Verification (eCAV) system. The eCAV system may then communicate with a Data Analysis (DA) system that may derive certain conclusions based around machine capability for the part and may then employ, for example, a logic tree to trigger a calibration to machine settings, to the a producibility advisor system, or a combination thereof. By automatically calibrating machine settings and/or the producibility advisor system, the part may be manufactured more efficiently and accurately.

A servicing and tracking set of processes 22 may also be provided via the CAx system 10. The servicing and tracking processes 22 may log maintenance activities for the part, part replacements, part life (e.g., in fired hours), and so on. As illustrated, the CAx system 10 may include feedback between the processes 12, 14, 16, 18, 20, 22. For example, data from services and tracking processes 22, for example, may be used to redesign the part or product via the design processes 14. Indeed, data from any one of the processes 12, 14, 16, 18, 20, 22 may be used by any other of the processes 12, 14, 16, 18, 20, 22 to improve the part or product or to create a new part or a new product. In this manner, the CAx system 10 may incorporate data from downstream processes and use the data to improve the part or to create a new part.

The CAx system 10 may additionally include one or more processors 24 and a memory system 26 that may execute software programs to perform the disclosed techniques. Moreover, the processors 24 may include multiple microprocessors, one or more “general-purpose” microprocessors, one or more special-purpose microprocessors, and/or one or more application specific integrated circuits (ASICS), or some combination thereof. For example, the processors 24 may include one or more reduced instruction set (RISC) processors. The memory system 26 may store information such as control software, look up tables, configuration data, etc. The memory system 26 may include a tangible, non-transitory, machine-readable medium, such as a volatile memory (e.g., a random access memory (RAM)) and/or a nonvolatile memory (e.g., a read-only memory (ROM), flash memory, a hard drive, or any other suitable optical, magnetic, or solid-state storage medium, or a combination thereof).

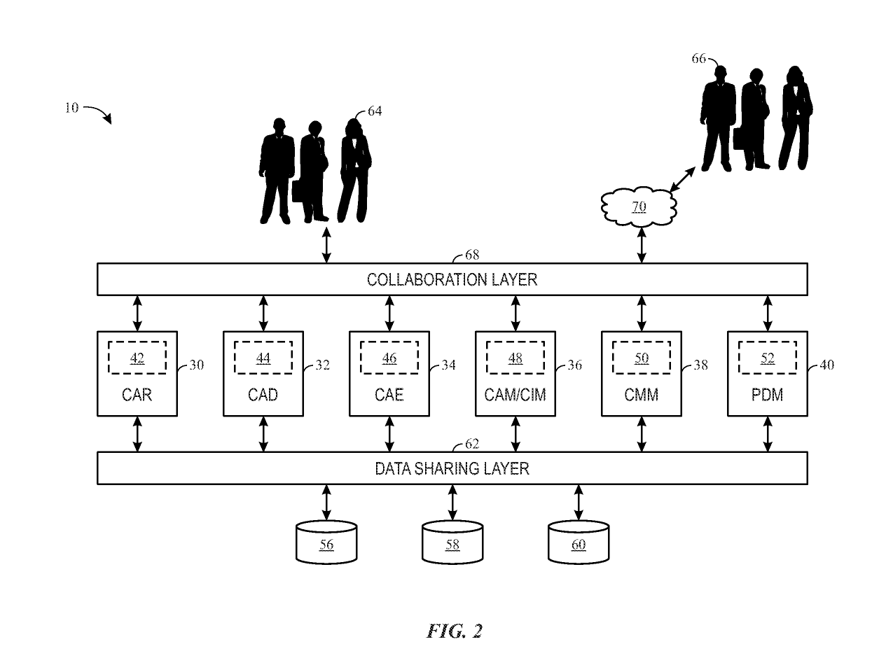

The memory system 26 may store a variety of information, which may be suitable for various purposes. For example, the memory system 26 may store machine-readable and/or processor-executable instructions (e.g., firmware or software) for the processors' 24 execution. In one embodiment, the executable instructions include instructions for a number of PLM systems, for example software systems, as shown in the embodiment of FIG. 2. More specifically, the CAx system 10 embodiment illustrates a computer-aided requirements capture (CAR) system 30, a computer-aided design (CAD) system 32, a computer-aided engineering (CAE) system 34, computer-aided manufacturing/computer-integrated manufacturing (CAM/CIM) system 36, a coordinate-measuring machine (CMM) system 38, and a product data management (PDM) system 40. Each of the systems 30, 32, 34, 36, 38 and 40 may be extensible and/or customizable, accordingly, each system 30 may include an extensibility and customization system 42, 44, 46, 48, 50, and 52, respectively. Additionally, each of the systems 30, 32, 34, 36, 38 and 40 may be stored in a memory system, such as memory system 26, and may be executable via a processor, such as via processors 24.

In the depicted embodiment, the CAR system 30 may provide for entry of requirements and/or specifications, such as dimensions for the part or product, operational conditions that the part or product is expected to encounter (e.g., temperatures, pressures), certifications to be adhered to, quality control requirements, performance requirements, and so on. The CAD system 32 may provide for a graphical user interface suitable to create and manipulate graphical representations of 2D and/or 3D models as described above with respect to the design processes 14. For example, the 3D design models may include solid/surface modeling, parametric models, wireframe models, vector models, non-uniform rational basis spline (NURBS) models, geometric models, and the like. The CAD system 32 may provide for the creation and update of the 2D and/or 3D models and related information (e.g., views, drawings, annotations, notes, and so on). Indeed, the CAD system 32 may combine a graphical representation of the part or product with other, related information. In some embodiments the CAD system 32, 2D and/or 3D models of a piping system may be translated to a universal file type that is importable to stress analysis software.

For example, the CAE system 34 may enable creation of various engineering models, such as the models described above with respect to the development/engineering processes 16. For example, the CAE system 34 may apply engineering principles to create models such as thermodynamic models, low cycle fatigue (LCF) life prediction models, multibody dynamics and kinematics models, computational fluid dynamics (CFD) models, finite element analysis (FEA) models, and/or three-dimension to two-dimension FEA mapping models. The CAE system 34 may then apply the aforementioned models to analyze certain part or product properties (e.g., physical properties, thermodynamic properties, fluid flow properties, and so on), for example, to better match the requirements and specifications for the part or product. Indeed, the CAE system 34 may perform an analysis (e.g., stress analysis) on a piping file that has been imported from the CAD system 32.

The CAM/CIM system 36 may provide for certain automation and manufacturing efficiencies, for example, by deriving certain programs or code (e.g., G-code) and then executing the programs or code to manufacture the part or product. The CAM/CIM system 36 may support certain automated manufacturing techniques, such as additive (or subtractive) manufacturing techniques, including material jetting, binder jetting, vat photopolymerization, powder bed fusion, sheet lamination, directed energy deposition, material extrusion, milling, lathing, plasma cutting, wire cutting, or a combination thereof. The CMM system 38 may include machinery to automate inspections. For example, probe-based, camera-based, and/or sensor-based machinery may automatically inspect the part or product to ensure compliance with certain design geometries, tolerances, shapes, and so on.

The PDM system 40 may be responsible for the management and publication of data from the systems 30, 32, 34, 36, and/or 38. For example, the systems 30, 32, 34, 36, and/or 38 may communicate with data repositories 56, 58, 60 via a data sharing layer 62. The PDM system 40 may then manage collaboration between the systems 30, 32, 34, 36, and/or 38 by providing for data translation services, versioning support, archive management, notices of updates, and so on. The PDM system 40 may additionally provide for business support such as interfacing with supplier/vendor systems and/or logistics systems for purchasing, invoicing, order tracking, and so on. The PDM system 40 may also interface with service/logging systems (e.g., service center data management systems) to aid in tracking the maintenance and life cycle of the part or product as it undergoes operations. Teams 64, 66 may collaborate with team members via a collaboration layer 68. The collaboration layer may include web interfaces, messaging systems, file drop/pickup systems, and the like, suitable for sharing information and a variety of data. The collaboration layer 68 may also include cloud-based systems 70 or communicate with the cloud-based systems 70 that may provide for decentralized computing services and file storage. For example, portions (or all) of the systems 30, 32, 34, 36, 38 may be stored in the cloud 70 and/or accessible via the cloud 70.

The extensibility and customization systems 42, 44, 46, 48, 50, and 52 may provide for functionality not found natively in the CAR system 30, the CAD system 32, the CAM/CIM system 36, the CMM system 38 and/or the PDM system 40. For example, computer code or instructions may be added to the systems 30, 32, 34, 36, and/or 38 via shared libraries, modules, software subsystems and the like, included in the extensibility and customization systems 42, 44, 46, 48, 50, and/or 52. The extensibility and customization systems 42, 44, 46, 48, 50, and 52 may also use application programming interfaces (APIs) included in their respective systems 30, 32, 34, 36, and 38 to execute certain functions, objects, shared data, software systems, and so on, useful in extending the capabilities of the CAR system 30, the CAD system 32, the CAM/CIM system 36, the CMM system 38 and/or the PDM system 40. By enabling the processes 12, 14, 16, 18, 20, and 22, for example, via the systems 30, 32, 34, 36, and 38 and their respective extensibility and customization systems 42, 44, 46, 48, 50, and 52, the techniques described herein may provide for a more efficient “cradle-to-grave” product lifecycle management.

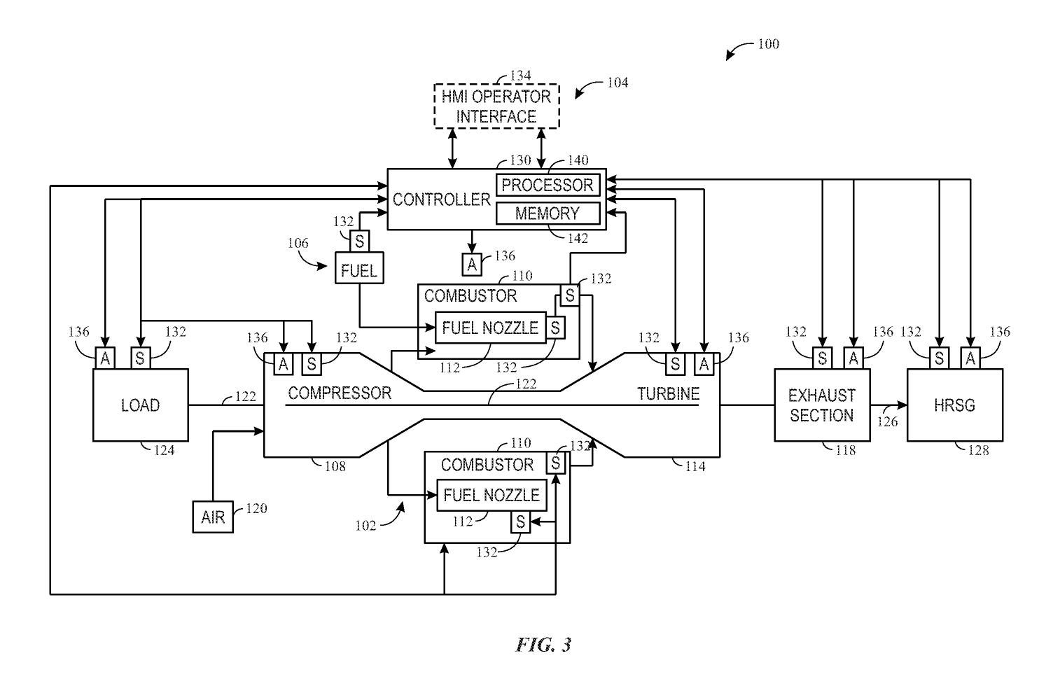

It may be beneficial to describe a machine that would incorporate one or more parts manufactured and tracked by the processes 12, 14, 16, 18, 20, and 22, for example, via the CAx system 10. Accordingly, FIG. 3 illustrates an example of a power production system 100 that may be entirely (or partially) conceived, designed, engineered, manufactured, serviced, and tracked by the CAx system 10. As illustrated in FIG. 1, the power production system 100 includes a gas turbine system 102, a monitoring and control system 104, and a fuel supply system 106. The gas turbine system 102 may include a compressor 108, combustion systems 110, fuel nozzles 112, a gas turbine 114, and an exhaust section 118. During operation, the gas turbine system 102 may pull air 120 into the compressor 108, which may then compress the air 120 and move the air 120 to the combustion system 110 (e.g., which may include a number of combustors). In the combustion system 110, the fuel nozzle 112 (or a number of fuel nozzles 112) may inject fuel that mixes with the compressed air 120 to create, for example, an air-fuel mixture.

The air-fuel mixture may combust in the combustion system 110 to generate hot combustion gases, which flow downstream into the turbine 114 to drive one or more turbine stages. For example, the combustion gases may move through the turbine 114 to drive one or more stages of turbine blades, which may in turn drive rotation of a shaft 122. The shaft 122 may connect to a load 124, such as a generator that uses the torque of the shaft 122 to produce electricity. After passing through the turbine 114, the hot combustion gases may vent as exhaust gases 126 into the environment by way of the exhaust section 118. The exhaust gas 126 may include gases such as carbon dioxide (CO₂), carbon monoxide (CO), nitrogen oxides (NOₓ), and so forth.

The exhaust gas 126 may include thermal energy, and the thermal energy may be recovered by a heat recovery steam generation (HRSG) system 128. In combined cycle systems, such as the power plant 100, hot exhaust 126 may flow from the gas turbine 114 and pass to the HRSG 128, where it may be used to generate high-pressure, high-temperature steam. The steam produced by the HRSG 128 may then be passed through a steam turbine engine for further power generation. In addition, the produced steam may also be supplied to any other processes where steam may be used, such as to a gasifier used to combust the fuel to produce the untreated syngas. The gas turbine engine generation cycle is often referred to as the “topping cycle,” whereas the steam turbine engine generation cycle is often referred to as the “bottoming cycle.” Combining these two cycles may lead to greater efficiencies in both cycles. In particular, exhaust heat from the topping cycle may be captured and used to generate steam for use in the bottoming cycle.

In certain embodiments, the system 100 may also include a controller 130. The controller 130 may be communicatively coupled to a number of sensors 132, a human machine interface (HMI) operator interface 134, and one or more actuators 136 suitable for controlling components of the system 100. The actuators 136 may include valves, switches, positioners, pumps, and the like, suitable for controlling the various components of the system 100. The controller 130 may receive data from the sensors 132, and may be used to control the compressor 108, the combustors 110, the turbine 114, the exhaust section 118, the load 124, the HRSG 128, and so forth.

In certain embodiments, the HMI operator interface 134 may be executable by one or more computer systems of the system 100. A plant operator may interface with the industrial system 10 via the HMI operator interface 134. Accordingly, the HMI operator interface 134 may include various input and output devices (e.g., mouse, keyboard, monitor, touch screen, or other suitable input and/or output device) such that the plant operator may provide commands (e.g., control and/or operational commands) to the controller 130.

The controller 130 may include a processor(s) 140 (e.g., a microprocessor(s)) that may execute software programs to perform the disclosed techniques. Moreover, the processor 140 may include multiple microprocessors, one or more “general-purpose” microprocessors, one or more special-purpose microprocessors, and/or one or more application specific integrated circuits (ASICS), or some combination thereof. For example, the processor 39 may include one or more reduced instruction set (RISC) processors. The controller 130 may include a memory device 142 that may store information such as control software, look up tables, configuration data, etc. The memory device 142 may include a tangible, non-transitory, machine-readable medium, such as a volatile memory (e.g., a random access memory (RAM)) and/or a nonvolatile memory (e.g., a read-only memory (ROM), flash memory, a hard drive, or any other suitable optical, magnetic, or solid-state storage medium, or a combination thereof).

Furthermore, the power production system 10 may include parts (e.g., piping parts) that have been designed utilizing computer aided design (CAD) software. Before implementation into the power production system 10, these CAD-designed parts may have been translated from the original design to operator-readable (e.g., human-readable) instructions utilizing a translation tool. An operator may have then utilized the instructions to create the designed part. This method may now be discussed in reference to the following figures.

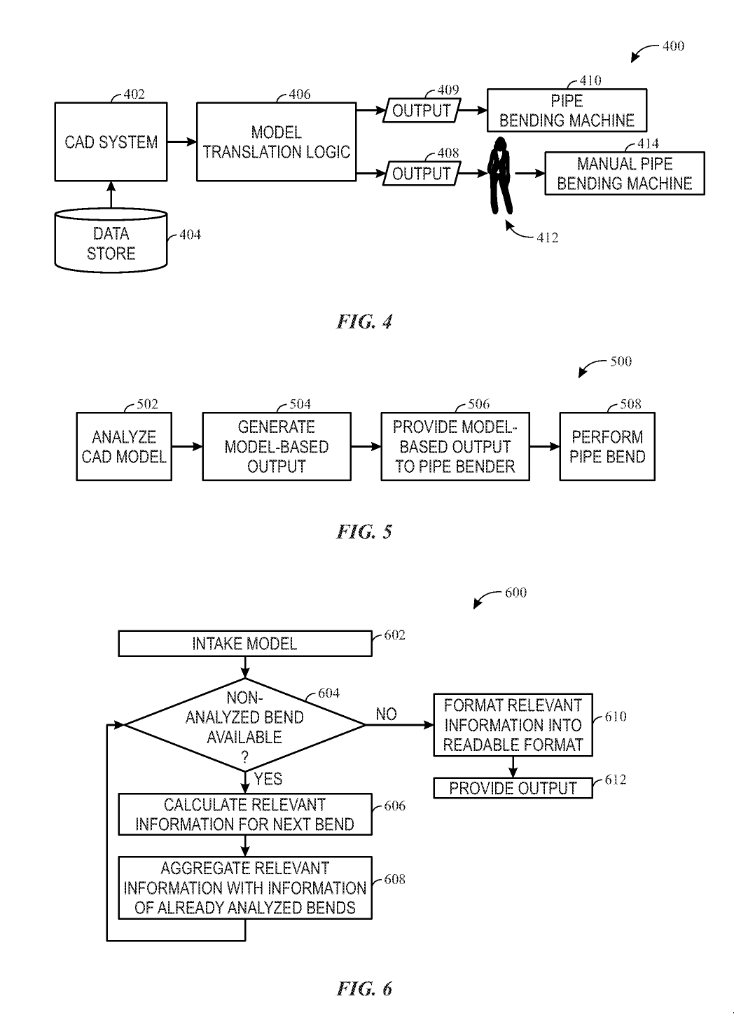

FIG. 4 is a block diagram of an embodiment of a system 400 that may provide an output to a pipe bending operator and/or machine. A pipe design may be produced in a CAD system 402. The pipe design may be a two-dimensional (2D) or a three-dimensional (3D) rendering in the CAD system 402. In some embodiments, the pipe design may be imported from a data store 404. The data store 404 may contain part files and/or assembly files that may be manipulated in the CAD system 402. Further the CAD system 402 and the data store 404 be communicatively coupled to a processor (e.g., processor 24). The processor may be configured to execute a set of instructions to translate the pipe design to operator-readable and/or machine-readable instructions utilizing model translation logic 406 (e.g., a model translation tool). In some embodiments, the model translation logic 406 may iterate through the pipe design while gathering relevant information on each portion (e.g., bend) of the pipe design. More specifically, the model translation logic 406 may mine underlying, data representative of the pipe design to gather the relevant information. Accordingly, the model translation logic 406 may not rely on a visual representation of the pipe design to gather the relevant information. Elements of the translation logic 406 may be discussed in more detail below in reference to FIG. 5.

Information that is gathered/calculated with the translation logic 406 may be compiled into operator-readable pipe bending instructions 408 and/or machine-readable pipe bending instructions 409. As illustrated, the operator-readable pipe bending instructions 408 and/or machine-readable pipe bending instructions 409 may be provided in more than one form. In some embodiments, the machine-readable pipe bending instructions 409 may be in the form of machine-readable code (e.g., a numerical control programming language (e.g., G code)) that is readable by a machine (e.g., a computer numeric control (CNC) machine). Accordingly, the operator-readable pipe bending instructions 408 and/or machine-readable pipe bending instructions 409 may be provided to a pipe bending machine 410 (e.g., a CNC pipe bending machine). The pipe bending machine 410 may intake a pipe spool and bend it to embody the pipe design utilizing information provided in the machine-readable pipe bending instructions 409. In some embodiments, the operator-readable pipe bending instructions 408 may be in a form that is readable by an operator 412 (e.g., operator readable) of a pipe bending machine. The operator-readable pipe bending instructions 408 that is operator readable may indicate particular settings an operator should use to bend a pipe, such as where to attach a manual pipe bending machine 414 to a pipe spool in order to make a bend specified in the operator-readable pipe bending instructions 408. For example, the operator-readable pipe bending instructions 408 and/or machine-readable pipe bending instructions 409 may indicate a location on a pipe spool on which to bend. The operator-readable pipe bending instructions 408 may also indicate to the operator 412 how much to rotate the pipe spool in between bends. Additionally and/or alternatively, the machine-readable instructions 409

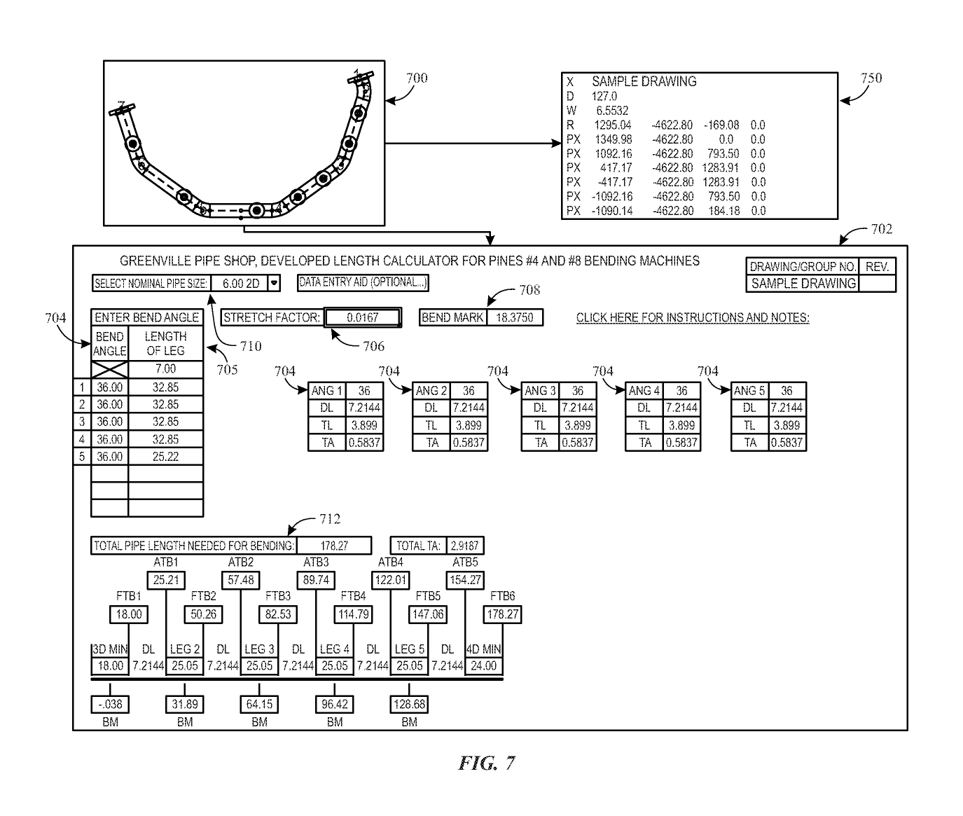

FIG. 5 is a block diagram of an embodiment of a pipe bending process 500. At block 502, a CAD model may be analyzed. In some embodiments, the CAD model may be a 2D and/or 3D piping model. As will be explained in further detail below in reference to FIG. 6, the piping model may be analyzed to gather relevant information regarding the design (e.g., without reference to/dependence on the visualization of the model). Relevant information may include, for example, an amount of piping that is consumed in a bend, an angle of a bend, and/or an angle of rotation relative to adjacent piping segments. Relevant information may also include a stretch factor of the pipe material/design. In some embodiments, the stretch factor may be predefined with respect to a pipe material and/or design. However, in some embodiments, the stretch factor may be derived for a particular design and/or material. Relevant information may further include bend mark locations. Bend mark locations may indicate where a pipe bending machine may clamp onto a pipe spool in order to accurately bend a pipe spool in accordance with the piping model.

More specifically, computer-interpretable instructions may traverse the underlying data representation of the model, mining the ascribed characteristics and features of the underlying model data to identify bends in the model. For example, these instructions may identify bend features in the model by mining the data for data representative of endpoints, intersections, and/or tangents of the piping model, which when taken in context of other portions of the model, indicate a bend is present. Further, in some models, the underlying data may include an explicit representation of bend features and their associated characteristics. The computer-readable instructions may use these features along with the relevant context of the bend features to the model to discern data useful for subsequent bend instruction calculation. For example, the model and/or model context may be mined to identify bent pipe endpoints, the actual bends in the pipe, intersections, and/or tangents may include utilizing the data to calculate relevant information discussed above (e.g., bend angles, pipe segment lengths, etc.). This mined data may be accumulated into a computer-interpretable bending object, which may be used by the computer for implementation of pipe bending calculation algorithms.

At block 504, a model-based piping instructions may be generated. Generating the model-based piping instructions may include generating a compilation of the relevant data into a desired format. As discussed above, the model-based piping instructions may include instructions 408 that are pipe-operator-readable (e.g., human-readable). In some embodiments, the model-based instructions may be readable by an operator who might operate a pipe bending machine. As such, the model-based instructions may be in the form of a spreadsheet and/or text-based document. As mentioned above, the instructions may include relevant information indicative of a piping model. For example, the instructions may include instructions on where (e.g., a location) to bend a pipe spool, an angle to bend a pipe spool, a total length of pipe for a design, and/or among other relevant instructions for pipe manufacturing/fabrication. In some embodiments, the model-based instructions may be computer-readable instructions (e.g., G-code). Accordingly, the model-based instructions may instruct a machine on where (e.g., a location) to bend a pipe spool, an angle to bend a pipe spool, a total length of pipe for a design, and/or among other relevant instructions for pipe manufacturing/fabrication.

At block 506, the model-based piping instructions may be provided for pipe bending. As mentioned above, in some embodiments, the model-based piping instructions may be provided to an operator of a pipe bending machine. Accordingly, the model-based output may be displayed on a screen and/or a printed paper in a readable format (e.g., spread sheet, text-based document, etc.). In some embodiments, the model-based piping instructions may include computer readable instructions (e.g., G-code). As such, a pipe bending machine (e.g., CNC pipe bending machine) may receive the model-based output via electronic communication (e.g., via Bluetooth, WiFi, a database, a data storage device, internet, etc.).

At block 508, a pipe bending operator and/or machine may bend the pipe according to the model-based piping instructions. In some embodiments, an operator may follow instructions to bend the pipe. In such embodiments, the pipe bending operator may include an operator and a pipe bending apparatus. The operator may receive model-based piping instructions. The operator may insert a pipe spool into the pipe bending apparatus and proceed to bend the pipe spool according to the model-based piping instructions. Operating the pipe bending apparatus may include inserting the pipe spool into the bending apparatus, performing a bend utilizing the bending apparatus, pulling the pipe spool out, rotating the pipe spool, reinserting the pipe spool, performing another bend utilizing the bending apparatus, and repeating as necessary. In some embodiments, the operator may insert the pipe spool, perform a bend, rotate the pipe spool, pull out the pipe spool, and so forth according to bend marks along the pipe. The bend marks are based on the model-based piping instructions and may indicate where to bend the pipe spool relative to a pipe length, where to clamp the pipe bending apparatus onto the pipe spool, how much to rotate (e.g., how many degrees of rotation) the pipe spool, and/or other instructions to create piping based on the model. In some embodiments, the bend marks may be markings that are placed directly on the pipe spool.

Alternatively, in some embodiments, the pipe bending may be conducted by a bending machine that interprets machine-readable instructions. In such embodiments, the pipe bending machine may receive model-based piping instructions, interpret the instructions, and perform one or more operations (e.g., bending, rotating, etc.) on a pipe spool based upon the interpreted instructions. In some embodiments, an operator may open a CAD model of a piping system utilizing a user interface, run a translation tool on the piping system, select a section of the piping system, select a direction to run a pipe spool through a pipe bending machine (e.g., CNC pipe bending machine), insert the pipe spool, and run the pipe bending machine, which may bend the pipe spool according the CAD model and a model-based piping instructions.

FIG. 6 is a process 600 for creating a model-based output for a pipe operator in accordance with an embodiment. In some embodiments, the process 600 may be executed via a processor (e.g., processor 24). The processor may intake a CAD model (block 602) of a piping system. At decision block 604, the processor may determine if a non-analyzed pipe bends exist in the CAD model. If non-analyzed pipe bends exist in the CAD model, the processor may calculate (e.g., analyze) relevant information for a next bend (e.g., non-analyzed pipe bend) (block 606). In some embodiments, calculating relevant information may include utilizing trigonometry to determine an angle of a bend, utilizing a stretch factor (which may be determined based on a pipe material) to determine an amount of material consumed in a bend (e.g., a length of pipe in a bend between adjacent linear piping segments), determining a total length of pipe to create the piping system, determining an angle of rotation between adjacent pipe segments, utilizing other relevant pipe bending information, etc.

At block 608, the processor may aggregate the relevant information with information of already analyzed bends. In other words, after the relevant information for a bend has been gathered, the processor may store the relevant information in a memory (e.g., memory system 26). After the relevant information for a pipe bend is aggregated (e.g., stored in the memory), the processor may once again determine if there a non-analyzed pipe bend available (block 604). The processor may continue to store relevant information for additional bends of a CAD model as the additional bends are analyzed.

Once all pipe bends of the piping system model have been analyzed and their relevant data is aggregated, the processor may format the aggregated relevant information into a desired format (block 610). As discussed above, the desired format may include computer-readable (e.g., pipe-bending-machine-readable) instructions (e.g., G-code). Additionally and/or alternatively, in some embodiments, the desired format may include a human-readable format (e.g., spreadsheet, text-based document, etc.).

At block 612, pipe-bending instructions based on the aggregated relevant information (e.g., the readable format) may be provided to a pipe operator and/or machine. As discussed above, the pipe-bending machine may include a CNC pipe bending machine, and in some embodiments, the pipe operator may include an operator and a pipe bending apparatus.

FIG. 7 illustrates embodiments of pipe bending instructions that may be provided. In some embodiments, CAD model 700 is representative of a piping system and may have been designed utilizing CAD software. In the current embodiment, the CAD model 700 is represented by a 2D rendering. In some embodiments, the CAD model 700 may be represented by a 3D rendering. As discussed above, the CAD model 700 may be analyzed to retrieve and aggregate relevant information. Relevant information may include characteristics useful for determining pipe bending instructions, such as: a stretch factor, a bend angle, a total length of pipe, a segment length of pipe, an amount of material (e.g., length) in a bend (e.g., consumed in a bend) and an angle from one pipe segment to the next.

Further, as discussed above, the relevant information may be aggregated and output as an operator-readable output. Such an output may be seen in output 702. Output 702 may be provided to an operator of a pipe bending machine. The operator may then operate the pipe bending machine as discussed in detail above while utilizing the output 702. In some embodiments, some factors of the output 702 may be derived (e.g., mined and/or calculated from mined data) from the CAD model 700. For example, one or more bend angles 704 and one or more lengths of legs 705 may be derived from the underlying data in the CAD model 700, by traversing the underlying computer representation of the model, without regard and/or dependence on the visualization of the model. Further, in some embodiments, some factors of the output 702 may be manually entered (e.g., via an input from an operator). For example, an operator may input (e.g., select) a stretch factor 706 and a nominal pipe size 710. Further yet, in some embodiments, some factors of the output 702 may be calculated from the derived factors (e.g., one or more bend angles 704 and one or more lengths of legs 705) and the manually entered factors (e.g., the stretch factor 706 and the nominal pipe size 710). For example, a developed length (DL), a tangent length (TL), a takeout allowance (TA), a 3D MIN, a bend mark 708 (BM), a forward tangent of bend (FTB), an aft tangent of bend (ATB), and a 4D MIN, and a total length of pipe used for bending 712 may be calculated from the one or more bend angles 704, the one or more lengths of legs 705, the stretch factor 706, and/or the nominal pipe size 710. The DL may be defined as a linear amount of pipe consumed through a bend. The TL may be defined as a straight line distance from a bend center to a bend tangent (e.g., an end of the bend). The TA may be defined as a relationship between the TL and DL. The TA may be used for checking (e.g., verification) purposes. The 3D MIN may be defined as a minimum amount of pipe used before a first bend tangent for the machine to clamp onto. The BM 708 may be defined as a marking on the pipe that designates a location of where to align the machine (e.g., clamp) before a bend is executed. The 4D MIN may be defined as a minimum amount of pipe used after the last bend tangent for the machine to clamp onto.

Another embodiment of an output may be seen in output 750. Output 750 may include pipe-bending machine instructions that are provided to a pipe-bending machine. More specifically, output 750 may include instructions having computer-readable information similar to the output 702. The pipe-bending machine may receive the output 750 operate as discussed in detail above.

It should further be noted that the actual configuration, format, and medium in which an output (e.g., output 702 and output 750) is expressed may change according to a type of pipe bender to which the output 702, 750 is being provided. In some embodiments, an output may not be produced before sending relevant information (e.g., pipe bending instructions) to a pipe manufacturer (e.g., pipe-bending operator and/or pipe-bending machine). In some embodiments, an analyzation tool may communicate directly to the pipe manufacturer to provide the relevant pipe bending information/instructions.

Technical effects of the current embodiments include analyzing a CAD model of a piping system to gather relevant manufacturing information. Relevant manufacturing information may include a pipe stretch factor, an angle of a pipe bend, an amount of material consumed in a pipe bend, a length of pipe between bends, and total pipe length in the piping system. The relevant information may be compiled into an output. The output may be provided to a pipe manufacturer (e.g., pipe-bending operator and/or pipe-bending machine). The pipe manufacturer may then bend a pipe spool according to instructions and/or relevant information included in the output. Overall, the embodiments discussed in the disclosure herein may accurately and efficiently translate a piping system based CAD model to instructions and/or relevant information which may be provided to a pipe manufacturer. The pipe manufacturer may then bend the pipe according to the provided output (e.g., compiled pipe bending instructions and/or relevant pipe bending information).

This written description uses examples to disclose the current embodiments, including the best mode, and also to enable any person skilled in the art to practice the current embodiments, including making and using any devices or systems and performing any incorporated methods. The patentable scope of the current embodiments are defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A tangible, non-transitory computer-readable medium, comprising machine-readable-instructions to:
access a computer aided design (CAD) model, wherein the CAD model comprises one or more bends;
traverse underlying data representative of the CAD model and mine bend-identifying characteristics of the underlying data useful to identify the one or more bends;
identify the one or more bends using the bend-identifying characteristics, the bend-identifying characteristics comprising bend data representative of end points, intersections, tangents, or any combination thereof, of the CAD model;
determine bend characteristics of each bend of the one or more bends, wherein at least a first portion of the bend characteristics comprises a portion of the bend-identifying characteristics and a second portion of the bend characteristics comprises data acquired by performing subsequent calculations on at least the bend data;
generate bending instructions based on the determined bend characteristics; and
provide the bending instructions to a pipe-bending manufacturer, wherein the bending instructions comprise human-readable instructions, and wherein the human-readable instructions comprise one or more bend mark locations, one or more bend angles, a stretch factor, a total length of piping, one or more pipe lengths disposed between adjacent bends, a nominal pipe size, or any combination thereof.

2. The tangible, non-transitory computer-readable medium of claim 1, wherein the bending instructions comprise machine-readable instructions.

3. The tangible, non-transitory computer-readable medium of claim 2, wherein the machine-readable instructions comprise instructions for a computer numeric control (CNC) pipe bending machine.

4. The tangible, non-transitory computer-readable medium of claim 2, wherein the machine-readable instructions comprise instructions to bend a pipe spool in accordance with the determined bend characteristics of the one or more bends of the CAD model.

5. The tangible, non-transitory computer-readable medium of claim 1, wherein the bend characteristics comprise the one or more bend angles, the stretch factor, the total length of piping, the one or more pipe lengths disposed between adjacent bends, the nominal pipe size, or any combination thereof.

6. The tangible, non-transitory computer-readable medium of claim 1, wherein the human-readable instructions comprise one or more bend mark locations.

7. (canceled)

8. The tangible, non-transitory computer-readable medium of claim 6, wherein the human-readable instructions comprise the one or more bend angles, the stretch factor, the total length of piping, the one or more pipe lengths disposed between adjacent bends, and the nominal pipe size.

9. A method, comprising:
receiving, via a processor, a piping CAD model;
traversing, via the processor, underlying data representative of the piping CAD model and mine bend-identifying characteristics of the underlying data useful to identify one or more bends of the piping CAD model;
identifying, via the processor, the one or more bends using the bend-identifying characteristics, the bend-identifying characteristics comprising bend data representative of end points, intersections, tangents, or any combination thereof, of the piping CAD model;
calculating, via the processor, relevant bending information for each bend of the one or more bends, wherein at least a first portion of the relevant bending information comprises a portion of the bend-identifying characteristics and a second portion of the relevant bending information comprises data acquired by performing subsequent calculations on at least the bend data;
aggregating, via the processor, the relevant bending information as relevant bending information is calculated for each bend;
formatting, via the processor, the relevant bending information into a readable format; and
providing, via the processor, the relevant bending information to a pipe-bending manufacturer, wherein the readable format comprises a human-readable format, and wherein the readable format comprises one or more bend mark locations, one or more bend angles, a stretch factor, a total length of piping, one or more pipe lengths disposed between adjacent bends, a nominal pipe size, or any combination thereof.

10. The method of claim 9, wherein the readable format comprises a machine-readable format.

11. (canceled)

12. The method of claim 10, wherein the relevant bending information comprises the one or more bend angles, the stretch factor, the total length of piping, the one or more pipe lengths disposed between adjacent bends, the nominal pipe size, or any combination thereof.

13. The method of claim 9, wherein the readable format comprises the one or more bend mark locations.

14. (canceled)

15. The method of claim 13, wherein the readable format comprises the one or more bend angles, the stretch factor, the total length of piping, the one or more pipe lengths disposed between adjacent bends, and the nominal pipe size.

16. A computer, comprising:
a memory; and
a processor configured to:
access a CAD model, wherein the CAD model comprises one or more bends;
traverse underlying data representative of the CAD model and mine bend-identifying characteristics of the underlying data useful to identify the one or more bends;
identify the one or more bends using the bend-identifying characteristics, the bend-identifying characteristics comprising bend data representative of end points, intersections, tangents, or any combination thereof, of the CAD model;
determine bend characteristics of each bend of the one or more bends, wherein at least a first portion of the bend characteristics comprises a portion of the bend-identifying characteristics and a second portion of the bend characteristics comprises data acquired by performing subsequent calculations on at least the bend data;
calculate bending instructions based on the determined bend characteristics; and
provide the bending instructions to a pipe-bending manufacturer, wherein the bending instructions comprise human-readable instructions, and wherein the human-readable instructions comprise one or more bend mark locations, one or more developed lengths, one or more tangent lengths, a total length of piping, or any combination thereof.

17. The computer of claim 16, wherein the bending instructions comprise machine-readable instructions for a computer numeric control (CNC) pipe bending machine

18. The computer of claim 16, wherein the bend characteristics comprise one or more bend angles, a stretch factor, the total length of piping, one or more pipe lengths disposed between adjacent bends, a nominal pipe size, or any combination thereof.

19. The computer of claim 16, wherein the human-readable instructions comprise the one or more bend mark locations.

20. The computer of claim 19, wherein the human-readable instructions comprise one or more bend angles, a stretch factor, the total length of piping, one or more pipe lengths disposed between adjacent bends, and a nominal pipe size.

21. The tangible, non-transitory computer-readable medium of claim 1, wherein the human-readable instructions comprise a graphical representation of the CAD model, wherein the graphical representation comprises a plurality of graphical indicators that are positioned relative to the graphical representation of the CAD model and are indicative of the one or more bend mark locations, the one or more bend angles, the stretch factor, the total length of piping, the one or more pipe lengths disposed between adjacent bends, the nominal pipe size, or any combination thereof.

22. The method of claim 9, wherein the human-readable format comprises a plurality of graphical representations indicative of the bending instructions, wherein each graphical representation of the plurality of graphical representations is associated with a respective bend of the one or more bends, and wherein each graphical representation comprises a bend angle, a developed length, a tangent length, and a takeout allowance associated with the respective bend of the one or more bends.

23. The computer of claim 16, wherein the processor is configured to:
receive a first input comprising a nominal pipe size associated with the CAD model; and
receive a second input comprising a stretch factor associated with the CAD model, wherein the bend characteristics comprise a bend angle and a length of leg for each of the one or more bends, and wherein the bending instructions are calculated based on the first and second inputs and the bend characteristics.
